(19) United States
(12) Patent Application Publication
(10) Pub. No.: US 2004/0085440 A1
(43) Pub. Date: May 6, 2004

(54) Method of digital video surveillance utilizing a dual camera monitoring system

(75) Inventors: Darius K. Fennell, Rochester, NY (US); Thomas M. Stephany, Churchville, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/284,991

(22) Filed: Oct. 31, 2002

(51) Int. Cl. H04N 7/18

(52) U.S. Cl. 348/42

(57) ABSTRACT

A dual-capture camera for capturing both digital and conventional images comprising: a housing having an inlet for receiving incident light; a mechanism for splitting the received incident light into two portions; an image sensor for sequentially capturing a plurality of digital images for forming a digital still image or digital video; and conventional film for receiving incident light from the beam splitter upon a predetermined criteria for capturing a conventional image having a time and date stamp; wherein, when the conventional image is date and time stamped, the digital image substantially corresponding in time to the captured conventional image is also date and time stamped with the same date and time stamp as the conventional image.

### CROSS-REFERENCE TO RELATED APPLICATIONS

The present application is related to U.S. application Ser. No. 10/245,857, filed Sep. 17, 2002, by Darius K. Fennell and Thomas M. Stephany, and entitled, “METHOD OF DIGITAL VIDEO SURVEILLANCE UTILIZING THRESHOLD DETECTION AND COORDINATE TRACKING”.

### FIELD OF THE INVENTION

The invention relates generally to the field of video surveillance and, more particularly, to such video surveillance which coordinates two or more specialized dual mode cameras synchronized to a programmed computer so that images recorded of suspicious activity are recorded for evidence, for example, as evidence in a court of law.

### BACKGROUND OF THE INVENTION

The proliferation of surveillance and its various uses is well known in the art and to a large percentage of the general populace. The presence of cameras in malls, airports, businesses, and even on the street has familiarized people with the fact that surveillance of some kind is regularly used. The function of such monitoring is both to prevent and identify crimes and to record activities at a vast number of locations. Since the identification of suspicious activity with such equipment is subject to the attention and lapses thereof by monitoring personnel, these video systems are often more effective at registering a singular blatant act, but are much less effective at identifying a single piece of suspicious activity, or a series of suspicious activities over a long period of time. Given these times of terrorist activity, these random and/or instantaneous acts that need intervention by proper authorities at a moment's notice, improvements in surveillance are both more desirable and valuable. Additionally, due to the legal requirements of criminal prosecution, evidence obtained in a security investigation needs to be both believable and admissible as evidence in a court of law.

U.S. Pat. No. 5,969,755 and U.S. Pat. No. 6,424,370 B1 disclose a motion based detection system and method that include providing a set of indexes derived from motion video. These disclosures provide means to detect motion. Through the addition of extra processing, events of interest such as appearance/disappearance, deposit/removal, entrance/exit and motion/rest can also be determined. However, these above prior art patents lack fundamental advantages that are necessary to build a successful monitoring system which specifically targets suspicious activity.

Additionally, co-pending, U.S. patent application Ser. No. 10/245,857 by Fennell, et al. discloses significant advantages over the present prior art. First, this invention permits the placement of a predetermined threshold value on what may be considered suspicious activity, and can therefore initiate formal tracking of an event based upon that preset threshold. Secondly, this invention can set a predetermined time limit for the aforementioned formal tracking. This predetermined time limit is initiated when the formally tracked suspicious activity falls below the predetermined threshold. Formal tracking will continue for the predetermined time limit, and lacking any further suspicious activity, record the last tracked frame as a still picture.

This evidence can be digital, but conventional image, silver halide (AgX) based photography, is typically accepted as favorable over a digital record, because of its chemical nature that is highly resistant to the tampering of its granular structure. This system will then return to random search activity for suspicious movement, using the predetermined threshold criteria. Thirdly, this invention uses a coordinate based tracking system that allows the suspicious events to be transferable from camera to camera. Since cameras of this invention have some zonal overlap, these cameras have the ability to transfer formal suspicious activity tracking from zone to zone and more specifically from spot to spot. These system attributes, along with the ability to signal the attention of distracted or inattentive security personnel to a suspicious event, create significant advantages for the tracking of suspicious activities.

Consequently, a need exists to prevent random and instantaneous acts of suspicious activity by determining which activities by individuals or groups thereof, are considered suspicious. Additionally, upon determination, a need exists to provide a way to automatically track those movements or activities without need for manual intervention by security personnel, and create indisputable records of nefarious activities.

### SUMMARY OF THE INVENTION

A dual-capture camera for capturing both digital and conventional images comprising: a housing having an inlet for receiving incident light; a mechanism for splitting the received incident light into two portions; an image sensor for sequentially capturing a plurality of digital images for forming a digital still image or digital video; and conventional film for receiving incident light from the beam splitter upon a predetermined criteria for capturing a conventional image having a time and date stamp; wherein, when the conventional image is date and time stamped, the digital image substantially corresponding in time to the captured conventional image is also date and time stamped with the same date and time stamp as the conventional image.

The above and other objects of the present invention will become more apparent when taken in conjunction with the following description and drawings wherein identical reference numerals have been used, where possible, to designate identical elements that are common to the figures.

### ADVANTAGEOUS EFFECT OF THE INVENTION

The present invention has the following advantage of preventing random acts of suspicious activity from being completed. It also provides means to automatically track suspicious movement from one monitored area to another, and gathers highly indisputable photographic evidence of suspicious or criminal activities.

### BRIEF DESCRIPTION OF THE DRAWINGS

FIG. 1 is a dual-capture camera system comprised of both film and digital capture means;

FIG. 2 is a dual-capture camera system with its internal digital and film based cameras time synchronized to a central computer;

FIG. 3 is a dual-capture camera system connected to the central computer that also runs specialized suspicious movement monitoring software; and

FIG. 4 shows both the digital and film-based images having time and date stamps.

### DETAILED DESCRIPTION OF THE INVENTION

Referring now to FIG. 1, there is a dual-capture camera system 10 of the security system of the present invention. The camera system 10 consists of a housing 12, and an entry lens 14 for allowing incident light 16 to enter housing 12. Incident light 16 is passed through the dual-capture camera system 10 by tracing rays 18. A beam splitter 20 splits the light reflected from a monitored scene so that two exact copies of the scene are directed to both the film-based camera 22 and the digital camera 24. Digital camera 24 contains a digital imaging mechanism such as a CCD 26 and the film-based camera 22 can contain a plurality of film types 28, such as 35 mm film.

Referring next to FIG. 2, there is shown the dual-capture camera system 10 described hereinabove. Analog film camera control line 30 connects between film based camera 22 and master control computer 34. Digital camera control line 32 connects between digital camera 24 and master control computer 34. The function of control lines 30 and 32 are to interrogate the CPU clock 36 of master control computer 34, with the intent to synchronize film camera clock 38 and digital camera clock 40 exactly with CPU clock 36. As will be described hereinbelow, the synchronization permits any time and date stamps produced by the cameras 22 and 24, and subsequently on any captured images by the cameras 22 and 24, to be precisely synchronized with the CPU clock 36.

Referring next to FIG. 3, the drawing details the dual-capture camera system 10 monitoring a particular area to be monitored 50. Monitored subject 48 carrying a briefcase 46 is continuously captured by the digital camera 24 when the subject 48 passes a threshold of what is considered suspicious movement. This threshold is disclosed in commonly assigned, pending U.S. patent application Ser. No. 10/245,857. The monitored subject 48 is tracked for a predetermined time limit, such as 20 seconds, and when the time limit is exceeded the film-based camera 22 captures a film-based image and the digital camera 24 captures a digital image. At the moment of image capture, the CPU clock 36 from computer 34 synchronizes the film camera clock 38 and digital capture camera clock 40. These clocks 38 and 40 respectively stamp their captured images with synchronized time and date.

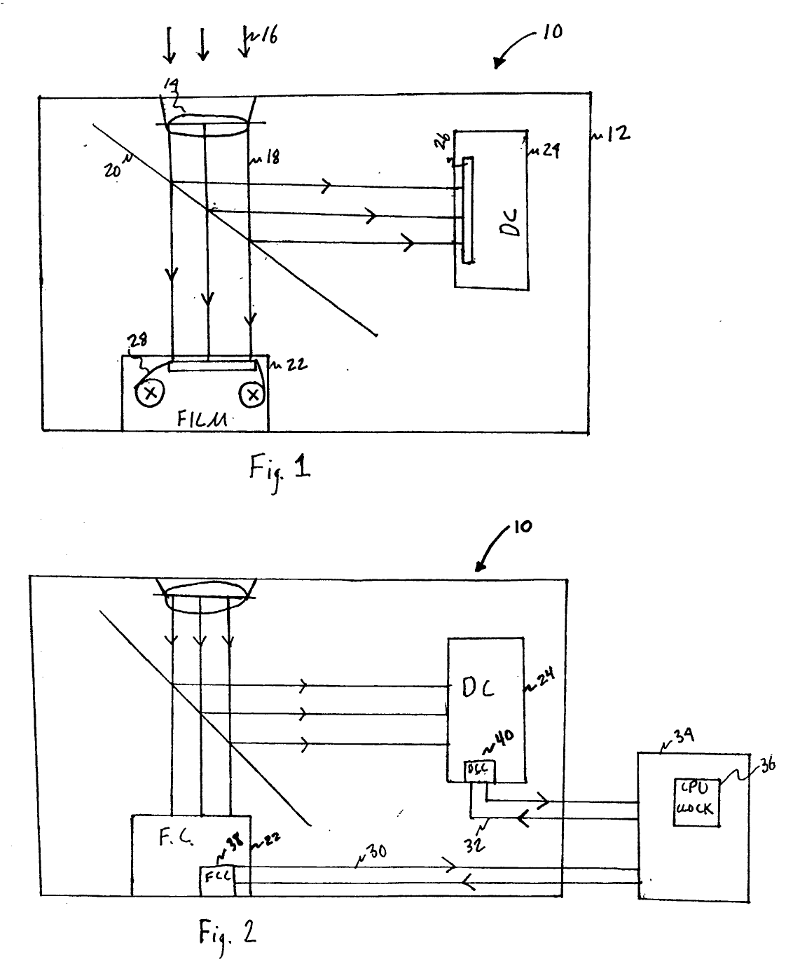

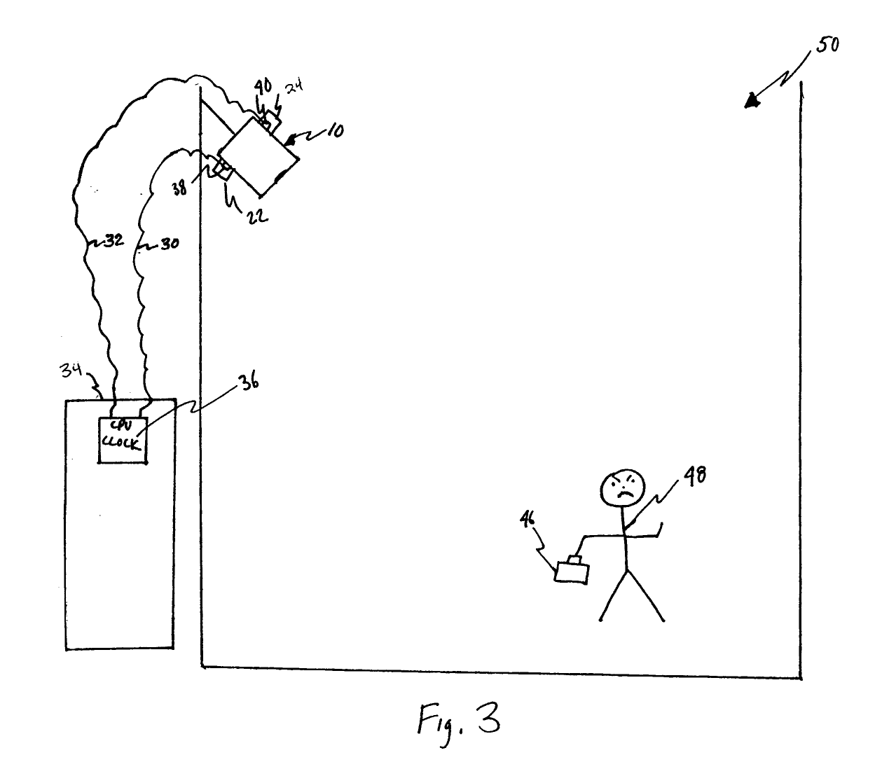

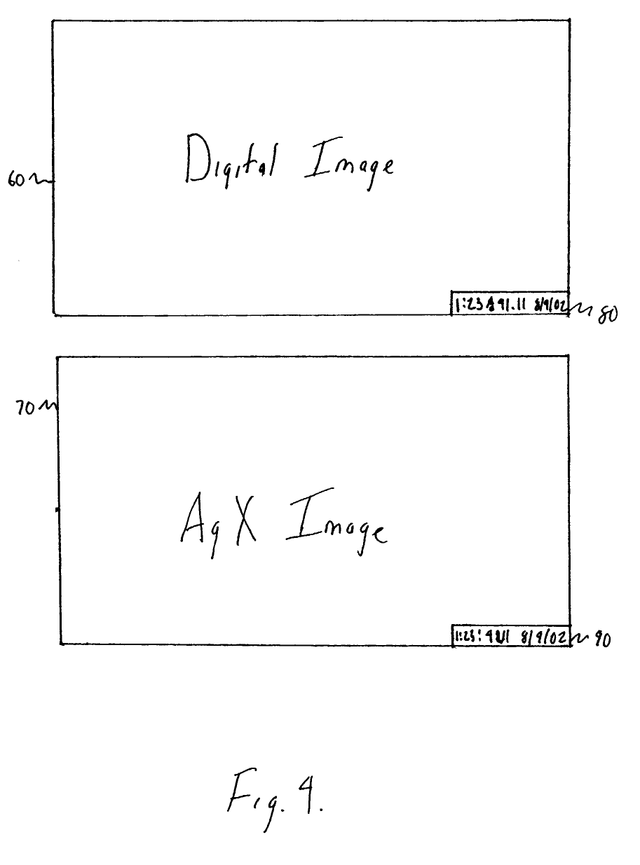

Referring lastly to FIG. 4, there is shown a digital image 60 and a film based image 70. Digital image 60 contains a digital time and date stamp 80 that matches the analog time and date stamp 90 from the film based image 70. The time and date stamp match the exact date and time down to 1/100 of a second. To verify if a digital image 60 of a particular digital time and date stamp 80 was suspected of physical alteration, it is a simple task to overlay the photographic information contained within film based image 70 of the identical analog date and time stamp 90 and make a comparison between the two frames. This process readily identifies the presence of digital alterations to the digital image 60.

The invention has been described with reference to a preferred embodiment. However, it will be appreciated that variations and modifications can be effected by a person of ordinary skill in the art without departing from the scope of the invention.

PARTS LIST

| | |
|---|---|
| 10 | dual-capture camera system |
| 12 | housing |
| 14 | entry lens |
| 16 | incident light |
| 18 | tracing rays |
| 20 | beam splitter |
| 22 | film-based camera |
| 24 | digital camera |
| 26 | CCD |
| 28 | plurality of film types |
| 30 | analog film camera control line |
| 32 | digital camera control line |
| 34 | master control computer |
| 36 | CPU clock |
| 38 | digital camera clock |
| 40 | digital camera clock |
| 46 | briefcase |
| 48 | subject |
| 50 | area to be monitored |
| 60 | digital Image |
| 70 | film based image |
| 80 | digital time and date stamped on digital image |
| 90 | analog time and date stamped on film based image |

What is claimed is:

1. A dual-capture camera for capturing both digital and conventional images comprising:
(a) a housing having an inlet for receiving incident light;
(b) a mechanism for splitting the received incident light into two portions;
(c) an image sensor for sequentially capturing a plurality of digital images; and
(d) conventional film for capturing an image upon a predetermined criteria, which image includes an occurrence stamp for indicating when an image is captured; wherein, when the conventional image is stamped, the digital image substantially corresponding in time to the captured conventional image is also stamped with the same stamp as the conventional image.

2. The dual-capture camera as in claim 1, wherein the occurrence stamp is a time and date stamp.

3. The dual-capture camera as in claim 2 further a processor for maintaining a synchronized date and time stamp.

4. The dual-capture camera as in claim 2 further comprising a computer programmed to monitor movement which passes a threshold and which prompts either the digital or conventional camera to capture an image.
